(19) United States
(12) Patent Application Publication
(10) Pub. No.: US 2011/0077986 A1
(43) Pub. Date: Mar. 31, 2011

(54) DECISION COST ANALYSIS FOR ENTERPRISE STRATEGIC DECISION MANAGEMENT

(75) Inventors: Gary DeGregorio, Sleepy Hollow, IL (US); William P. Alberth, JR., Prairie Grove, IL (US); Mark Lemke, Mundelein, IL (US)

(73) Assignee: MOTOROLA, INC., Schaumburg, IL (US)

(21) Appl. No.: 12/571,256

(22) Filed: Sep. 30, 2009

(51) Int. Cl. G06Q 10/00; G06N 5/02

(52) U.S. Cl. 705/7; 706/46

(57) ABSTRACT

A method of managing decisions. The method can include identifying decision costs expended or projected to be expended for each of a plurality of decisions in a decision network and determining whether a sum of the decision costs expended or projected to be expended exceed at least one assigned cost threshold warning level. When the sum of the decision costs expended or projected to be expended exceed the assigned cost threshold warning level, a cost warning alert can be automatically generated and electronically communicated. The cost warning alert can indicate that the cost threshold warning level has been exceeded or is projected to be exceeded.

### BACKGROUND OF THE INVENTION

1. Field of the Invention

The present invention generally relates to computer information systems and, more particularly, to systems that manage decision processes.

2. Background of the Invention

Decision making is a routine process in virtually every type of organization. Oftentimes the decisions that are made have financial repercussions, both short term and long term. The financial repercussions may be beneficial, for instance when a decision is made by a business to enter a developing market segment that turns out to be profitable. The financial repercussions also may be harmful, however, for example when a decision is made to invest in developing a new technology that in the end, proves unmarketable. Thus, the quality of decisions made by an organization generally has an effect on the overall success of the organization.

That being said, certain decisions have much greater impact on an organization in relation to other decisions. In illustration, a decision to proceed with construction of a new manufacturing facility requires a significant commitment of financial resources, and thus carries with it a greater risk than a decision to purchase additional laboratory equipment. Accordingly, it generally behooves an organization to commit adequate organizational resources, both in terms of financial resources and human resources, when making decisions regarding large capital investments. Conversely, when a decision that carries little risk is to be made, it would not be prudent for an organization to allocate significant resources that may be of better use elsewhere within the organization.

Although these concepts are generally understood by those seasoned in business management, organizational structures and communication channels add complexity to the decision process, which can inhibit an organization from implementing proper decision processes. Indeed, it is not uncommon for an organization to lose sight of the resources that are consumed in pursuit of reaching a decision, and the cost of such resources sometimes outweighs the associated risk. On the other hand, decisions are sometimes made without the requisite level of analysis and understanding, resulting in low quality decisions that expose an organization to unnecessary risks that otherwise would be avoided with proper oversight.

### SUMMARY OF THE INVENTION

The present invention relates to a method of managing decisions. The method can include identifying by an electronic system decision costs expended or projected to be expended for each of a plurality of decisions in a decision network and, with the electronic system, determining whether a sum of the decision costs expended or projected to be expended exceed at least one assigned cost threshold warning level. When the sum of the decision costs expended or projected to be expended exceed the assigned cost threshold warning level, a cost warning alert can be automatically generated. The cost warning alert can indicate that the cost threshold warning level has been exceeded or is projected to be exceeded. The cost warning alert can be presented on a user interface of the electronic system.

Yet another embodiment of the present invention can include a computer program product including a computer-usable medium having computer-usable program code that, when executed, causes a machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts an example of a decision network that is useful for understanding the present invention;

FIG. 2 is a flowchart presenting a method of decision planning that is useful for understanding the present invention;

FIG. 3 is a flowchart presenting another method of decision planning that is useful for understanding the present invention;

FIG. 4 is a flowchart presenting another method of decision planning that is useful for understanding the present invention;

FIG. 5 depicts a block diagram of a decision management system that is useful for understanding the present invention; and

FIG. 6 depicts an electronic system that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Arrangements described herein relate to a method of managing decisions and a decision management system. More specifically, the inventive arrangements provide a method and a system that tracks costs associated with decision processes and generates alerts that indicate when the costs associated with specific decisions exceed decision thresholds, and/or when costs associated with groups of decisions exceed group decision thresholds.

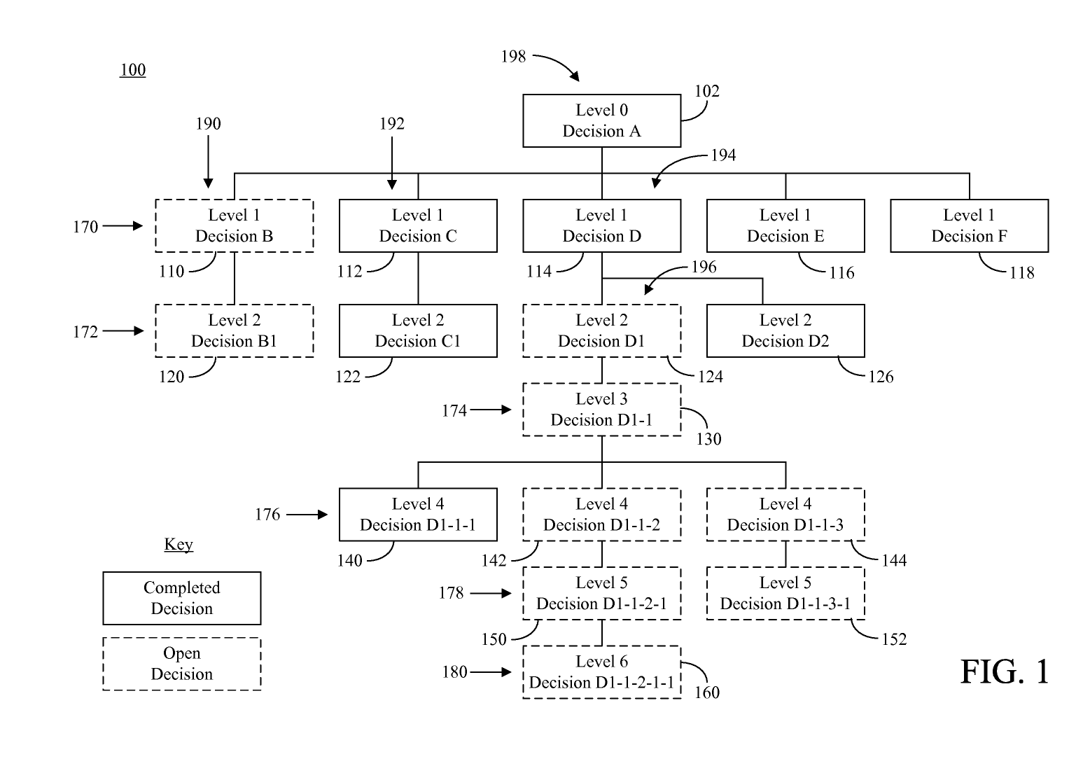

FIG. 1 depicts an example of a decision network 100 that is useful for understanding the present invention. The decision network 100 can include a plurality of decisions 102, 110, 112, 114, 116, 118, 120, 122, 124, 126, 130, 140, 142, 144, 150, 152, 160, each of which is represented as a block in the decision network 100. The decisions 102-160 are loosely coupled, but logically related in a hierarchical manner. For the purposes of illustration, completed decisions 102, 112-118, 122, 126, 140 are depicted in the decision network 100 as blocks which have a solid border, while decisions 110, 120, 124, 130, 142-160 not yet completed (i.e. open decisions) are depicted as blocks with a dashed border. The significance of completed decisions and open decisions will be discussed herein in further detail.

Each decision 102-160 within the decision network 100 can be modeled and analyzed using any suitable decision analysis methodology (e.g. influence diagrams, decision trees, multi-criteria decision-making, such as the Kepner-Tregoe decision-making method or analytical hierarchy process (AHP), and so on). In one arrangement, a common decision analysis method can be applied to make each of the decisions 102-160. In another arrangement, the decision analysis applied to each decision 102-160 can be selected based on the type of decision to be made (e.g. technology selection, financial, strategy, etc.).

The decisions 102-160 can be represented in the decision network 100 by a decision hierarchy in which a number of decision groups are defined. As used herein, the term “decision group” means a group of two or more decisions wherein a single decision is at a decision level that is higher than the decision levels of any other decisions in that decision group. In other words, a decision group comprises a primary decision at the highest decision level within the decision group, and one or more associated subordinate decisions that are at lower decision levels in the decision network 100 than the decision level of the primary decision. That said, a decision which is a subordinate decision in a first decision group may be a primary decision in another decision group.

In illustration, the decision 110 can be associated with a decision 120 that is at a lower decision level 172 within the decision network 100 than the decision level 170 at which the decision 110 is located. Hence, the decisions 110, 120 can be considered a decision group 190, with the decision 110 being the primary decision and the decision 120 being a subordinate decision. Similarly, the decisions 112, 122 can be considered a decision group 192 with the decision 112 being the primary decision and the decision 122 being a subordinate decision. The decision 114 is associated with decisions 124-160, so all such decisions can be considered a decision group 194 in which the decision 114 is the primary decision and the decisions 124-160 are subordinate decisions.

Further, decisions 124, 130, 140-144, 150-152 and 160 can be considered a decision group 196 in which the decision 124 is the primary decision and the other decisions 130, 140-144, 150-152 and 160 are subordinate decisions. However, the decision 124 can be a subordinate decision in the decision group 194. Accordingly, the decision group 196 can be referred to as a sub-group of the decision group 194. Likewise, the decision groups 190-194 each can be considered sub-groups of the decision group 198 that includes all of the decisions 102-160. In this decision group 198, the target decision 102 is the primary decision and the decisions 110-160 are subordinate decisions.

At this point it should be noted that decision groups can be defined by any other logical relationships. Indeed, the decisions 102-160 need not all be in the same decision network or decision hierarchy. For example, if a company wishes to decide whether to manufacture a particular product, the decision network 100 may include all the decisions 102-160 for defining and manufacturing the product. In another arrangement, decisions 114, 124-160 for defining the product may be defined in a first decision network or hierarchy, and decisions 112, 122 for determining where to manufacture the product may be defined in a second decision network or hierarchy. Still, the decisions 102-160 can be arranged in any other suitable decision network(s) or decision hierarchy/hierarchies, and the invention is not limited in this regard.

The primary decision in a decision group typically limits the scope of subordinate decisions in the decision group, though this need not be the case. For instance, a decision 114 of a decision group 194 can limit the scope of the decisions 124, 130, 140, 142, 144, 150, 152, 160. In illustration, if the decision 114 pertains to a determination of whether to pursue a new product line, the decisions 124-160 can be limited to decisions that are narrower in scope, but still related to the new product line. For instance, the decision 126 can pertain to the marketing strategy for the new product line.

Various types of decision groups may be implemented in accordance with the inventive arrangements. For example, a primary decision and one or more subordinate decisions on which the primary decision is based, at least in part, may be referred to as a rollup decision group. In addition to subordinate decisions, other factors (not shown) also may influence primary decisions in a rollup decision group. In other words, although a primary decision in a rollup decision group may be based on one or more subordinate decisions, the subordinate decisions need not necessarily bind the higher level decision to a particular determination.

In the present example, a target decision 102 to be made can be identified as “level 0, decision A” in the decision network 100, and can be based on any number of subordinate decisions. For instance, the target decision 102 can be based on a plurality of decisions 110, 112, 114, 116, 118 which are made at the first decision level 170 that is subordinate to the decision 102. Further, the decisions 110-118 can be based on other subordinate decisions 120, 122, 124, 126 at the second decision level 172, and so on. Nonetheless, one or more of these decisions can be based on other decisions lower in the decision hierarchy. For example, the decision 110 can be based on a decision 120 at the second decision level 172 of the decision hierarchy. Similarly, the decisions 112 can be based on a decision 122 at the second decision level 172 of the decision hierarchy. In contrast to the decisions 120, 122, the decision 114 can be based on a plurality of decisions, namely decision 124 and a decision 126, both of which are at the second decision level 172.

Continuing further, the decision 124 can be based on a decision 130 at the third level 174 of the decision hierarchy, and the decision 130 can be based on the decisions 140, 142, 144 at the fourth level 176. The decision 142 can be based on the decision 150 at the fifth level 178, and the decision 144 can be based on the decision 152. Finally, the decision 150 can be based on the decision 160 at the sixth decision level 180. Notwithstanding this example, any number of decisions and any number of decision levels may be implemented and the invention is not limited in this regard. Moreover, a decision that is a primary decision in one decision group can be a subordinate decision in one or more other decision groups.

In contrast to a rollup decision group, a constrained decision group comprises a primary decision and one or more subordinate decisions that are constrained by the primary decision. In a constrained decision group, for example the decision group 194, the primary decision 114 can constrain subordinate decisions 124-160 made at various decision levels 172, 174, 176, 178, 180 which are lower than the decision level 170 of the primary decision 114 in the decision network 100. In other words, the decisions 124-160 can be made after the primary decision 114 has been made, and the scope of the decisions 124-160 can be based on the result of the primary decision 114.

Information related to the primary decision 114 also can be provided to owners associated with the decisions 124-160 to guide such owners in their respective decision processes. As used herein, the term “owner” means a person who is tasked with managing the decision processes for a decision in order to make the decision or a person who is accountable for the outcome of the decision.

In a constrained decision group, a primary decision 114 can provide information to owners of subordinate decisions 124-160 through a set of constraints that are automatically associated with the subordinate decisions 124-160. In a rollup decision group, information related to subordinate decisions 124-160 can be provided to the owner of the primary decision 114 as a set of intermediate choices that may be used by the owner of the primary decision 114 to complete the primary decision 114. In this regard, the intermediate choices can be automatically associated with the primary decision 114 when the intermediate choices are made.

In any of these cases, the constraints and/or choices can be associated with the appropriate decisions 102-160 at the time the decisions are completed 100, after the decisions have been reviewed and approved, or at any other time that is deemed suitable. In one example, the constraints and/or intermediate choices can be communicated to other suitable decision owners via email. In another example, the constraints and/or intermediate choices can be entered into an application tasked with managing the decision process. In addition to tracking decision goals, the application can define which subordinate decisions need to be made and in which order such decisions need to be made. In addition, reminders can be sent to decision owners of upcoming deadlines. Further, once decisions are made and entered into the application, the application can generate reminders to other relevant decision owners as to the status of various decisions and/or actions that are necessary to continue the decision process. The application also can maintain relationships between this information to further enhance the maintainability of the decision network(s) 100.

By way of example, if the target decision 102 relates to developing a product for a new market segment, the decision 110 can relate to the target list price of the product, and the decision 120 can relate to the target manufacturing cost of the product. The target decision 102 of whether to develop the product can be made first. Then, the decision 110 relating to the target list price of the product can be determined. Once the decision 110 has been made, the information related to the target list price can be conveyed to the owner of the decision 120 and used to constrain the scope of the decision 120. For instance, if the target list price selected by the decision 110 is one hundred dollars, the target manufacturing cost selected by the decision 120 can be equal to or less than forty dollars.

Having described both rollup decision groups and constrained decision groups, it will be appreciated by one skilled in the art that the inventive arrangements can implement one or more rollup decision groups and/or one or more constrained decision groups. In this regard, the term “decision group,” as used herein, may refer to a rollup decision group and/or refer to a constrained decision group.

For any particular decision group 190, 192, 194, 196, the costs associated with the entire decision group can correspond to the summation of costs associated with each of the decisions within that particular decision group 190, 192, 194, 196. For instance, the cost associated with the decision group 190 can correspond to a summation of costs associated with the decisions 110, 120. Similarly, the costs associated with the decision group 192 can correspond to the summation of costs associated with the decisions 112, 122, and so on.

The decision 124 can pertain to the fixed overhead resources to allocate to the new product line, while the decision 130 can pertain to facilities that may be required. Since the size of a facility that is required generally depends on the staffing levels that will be required, the manufacturing space that will be needed, and the amount of administrative space that will be required, etc., the decision 140 can pertain to the staff that will be needed to support the product line, the decision 142 can pertain to the manufacturing equipment that will be needed to produce the products, and decision 144 can pertain to the office space that will be needed, and so on.

In one arrangement, the various decisions 102, 110-160 in the decision network 100 can be entered and maintained in a decision management database or another suitable data management structure. For simplicity, hereinafter any suitable data management structures will be referred to as “decision management database.” Nonetheless, those skilled in the art will appreciate that the decision management database can include any number of data structures (e.g., data tables), and these data structures need not be maintained on the same processing device. The decisions 102, 110-160 can be entered into the decision management database by a user using a suitable user interface, or by an application configured to enter such decisions into the decision management database.

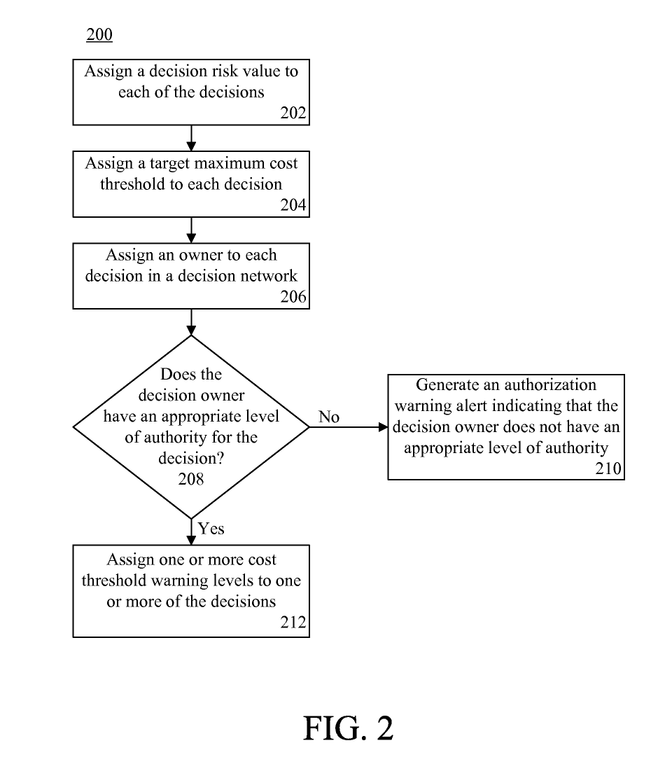

Referring now to FIG. 2, a flowchart depicting a method 200 of decision planning that is useful for understanding the present invention. The method 200 can be implemented to assign owners to decisions in the decision network, assign decision risk values to the decisions, assign target cost thresholds to the decisions, and assign one or more cost threshold warning levels, as will be described. These cost threshold warning levels can be assigned to individual decisions and/or as aggregate cost threshold warning levels for one or more decision groups.

At step 202, each decision in the decision network can be assigned a decision risk value. As used herein, the term “decision risk value” means a value at risk that corresponds to a particular decision. The decision risk value may be defined in terms of money to be invested, opportunity costs, or defined in any other suitable manner. For a given decision group, the decision risk value associated with the primary decision can include each of the decision risk values for each of the subordinate decisions upon which the primary decision is based. By way of example, if a primary decision is based on a second decision and a third decision, the decision risk value assigned to the primary decision can include a sum of the decision risk values assigned to the second and third decisions. In addition, the decision risk value assigned to the primary decision also may include the value at risk associated with that decision, but are not included in the decision risk values of the first and second decisions. Notably, not all decision risk values associated with a particular decision group need be of equal value. Indeed, the decision risk values can significantly vary.

To determine a decision risk value of a decision, the risks associated with the decision can be evaluated. For instance, the financial investment that may be required if a particular decision is made can be evaluated. Further, values can be assigned to resources needed to implement the results of the decision, potential legal issues, impact on other operations, impact on customer relations, etc. In one arrangement, the various decision risk values associated with the decisions in the decision network, as well as the monetary values associated with such risks, can be entered into the decision management database.

The risks and their monetary values can be assigned by the owner of the decision, or an owner of a primary decision in a decision group in which the subject decision is a subordinate decision. In another arrangement, the risks and their monetary values can be assigned by a committee, determined based on computer-usable program code (e.g., an application) and automatically assigned to the decision, or assigned to the decision in any other suitable manner.

Regardless of how the risks and their monetary values are determined, the risks and monetary values can be processed to generate the decision risk value for each decision. Further, one or more reviewers can review the decision risk values and adjust the decision risk values as appropriate. Moreover, an assigned decision risk value can be adjusted over time as conditions on which the decision risk value is based evolve.

At step 204, a target maximum cost threshold can be assigned to one or more decisions or decision groups in the decision network. As used herein, a maximum cost threshold is a desired maximum cost that will be associated with making a particular decision. In one arrangement, the maximum cost threshold for a decision can be a percentage of the assigned decision risk value. For example, the percentage can be in the range of 0.1 percent to ten percent. Nonetheless, any other desired percentages may be used and the invention is not limited in this regard.

At step 206, an owner can be assigned to each decision in the decision network. A person may be assigned to be an owner of one decision, or a plurality of decisions. The decisions and their respective owners can be entered into the decision management database.

At decision box 208, a determination can be made as to whether the decision owner has an appropriate level of authority for the subject decision. This decision can be made by an electronic system on which a decision management application is instantiated. If the costs associated with the decision exceed, or are projected to exceed, an amount for which the decision owner is authorized to manage, a determination can be made by the electronic system that the owner does not have the appropriate level of authority to own that decision. If the decision owner does not have appropriate level of authority required to own the decision, at step 210 an authorization warning alert can be generated. Such authorization warning alert also can indicate that a new owner needs to be assigned to the decision. The authorization warning alert can be presented on a user interface of the electronic decision.

The authorization warning alert can be electronically communicated. The authorization warning alert can comprise, for example, an e-mail, text message, or other indicator communicated to one or more users (e.g., persons), for example the owner of the decision, the owner of a primary decision to which the subject decision is a subordinate decision, owners of lower level decisions below the decision creating the alert, management personnel, etc. In another arrangement, the authorization warning alert can comprise a message which is presented via a user interface of an electronic system, for instance in an application in which the method 200 is implemented or any other desired application. Still the authorization warning alert(s) can be presented in any other suitable manner and the invention is not limited in this regard.

Further, data pertaining to decisions in which the respective decision owners lack an appropriate level of authority can be stored to the decision management database. This data can be analyzed to evaluate trends relating to decision owners expending more costs than they are authorized. The analysis of the data can be output. For example, the analysis can be stored to the decision management database, communicated to one or more decision owners, communicated to one or more managers, presented on a user interface of an electronic system, or the like.

At step 212, one or more cost threshold warning levels can be assigned to one or more of the respective decisions. For example, a cost threshold warning level can be assigned to each decision within a decision group or each decision within the decision network.

Each cost threshold warning level can be a percentage of the maximum cost threshold that is assigned to the respective decision or decision group. For instance, for a particular decision, a cost threshold warning level can be assigned at a first percentage (e.g., 25%) of the associated maximum cost threshold, a second percentage (e.g., 50%) of the associated maximum cost threshold, a third percentage (e.g., 75%) of the associated maximum cost threshold, and so on. The number of cost threshold warning levels and the cost threshold warning level percentages need not be the same for each decision. Indeed, a particular decision may have only one cost threshold warning level assigned, for instance 80%, while another decision has multiple cost threshold warning levels, none of which are 80%. Still, other decisions may have no assigned cost threshold warning levels that are less than their maximum cost thresholds. In this case, the maximum cost thresholds may be used as the cost threshold warning levels.

The maximum cost threshold and/or cost threshold warning level(s) also can be stored to the decision management database. The maximum cost threshold and/or cost threshold warning level(s) for a decision can be assigned by the decision owner, or an owner of a primary decision for a decision group in which the subject decision is a subordinate decision. The maximum cost threshold and/or cost threshold warning level(s) also can be assigned by a committee, determined by computer-usable program code and automatically assigned to the decision, or assigned to the decision in any other suitable manner.

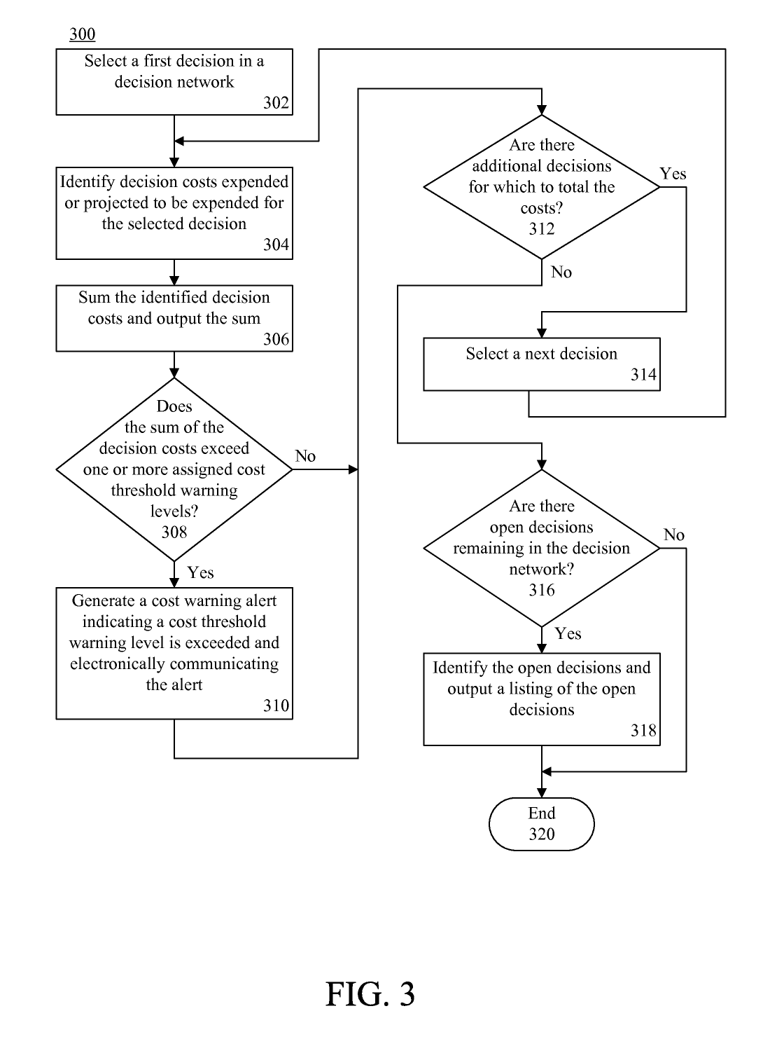

FIG. 3 is flowchart depicting another method 300 of decision planning that is useful for understanding the present invention. The method 300 can be implemented by an electronic system to monitor costs actually expended for various decisions in the decision network, and to generate alerts when costs exceed, or are projected to exceed, cost threshold warning levels. Alerts also can be generated for other conditions, as will be described.

The method 300 can be implemented using data assigned to the respective decisions, for instance as described in the method 200 of FIG. 2. In one arrangement, the method 300 can be implemented periodically. In another arrangement, the method 300 can be implemented in response to triggers, for instance input of costs expended for one or more decisions, input of data assigned to one or more decisions, or in response to any other type of trigger. In yet another arrangement, the method 300 can be performed continually while the decision network is active.

At step 302, a first decision in a decision network can be selected. At step 304, the decision costs expended, or projected to be expended, for the selected decision can be identified. Such costs can be based on the amount of time employees invest into the decision process, costs paid to consultants and outside vendors as part of the decision process, costs to manufacture and test prototypes, costs for preparing and testing prototype devices, etc. In addition, such costs can be stored in the decision management database and associated with the decision. At step 306, the identified costs (e.g., expended and/or projected to be expended) can be summed, and the sum can be output. For example, the sum of the identified costs can be stored in the decision management database, or any other suitable database, and associated with the decision.

Referring to decision box 308, if the sum of the decision costs expended or projected to be expended for the decision exceed, or are projected to exceed, one or more assigned cost threshold warning levels, at step 310 a cost warning alert can be generated indicating that the cost threshold warning level has been exceeded. The alert can be electronically communicated. The cost warning alert can comprise, for example, an e-mail, text message, or other indicator communicated to one or more users (e.g., persons), for example the owner of the decision, the owner of a primary decision to which the subject decision is a subordinate decision, owners of lower level decisions below the decision creating the alert, management personnel, etc. In another arrangement, the cost warning alert can comprise a message which is presented via a user interface in an application in which the method 300 is implemented or any other desired application. Still the cost warning alert(s) can be presented in any other suitable manner and the invention is not limited in this regard.

At decision box 312, a determination can be made as to whether there are additional decisions for which to total the costs. If there are additional decisions, at step 314 a next decision can be selected. The method 300 then can return to step 304.

If there are no additional decisions, at decision box 316, a determination can be made whether there are open decisions remaining in the decision network. If there are open decisions remaining, at step 318 the open decisions can be identified and a listing of open decisions can be output. For example, the listing of open decisions can be stored to the decision management database, or electronically communicated to one or more decision owners. In another arrangement, an active list of open decisions can be maintained.

If there are no open decisions remaining, at step 320 the process can end. Alternatively, the process can return to step 302.

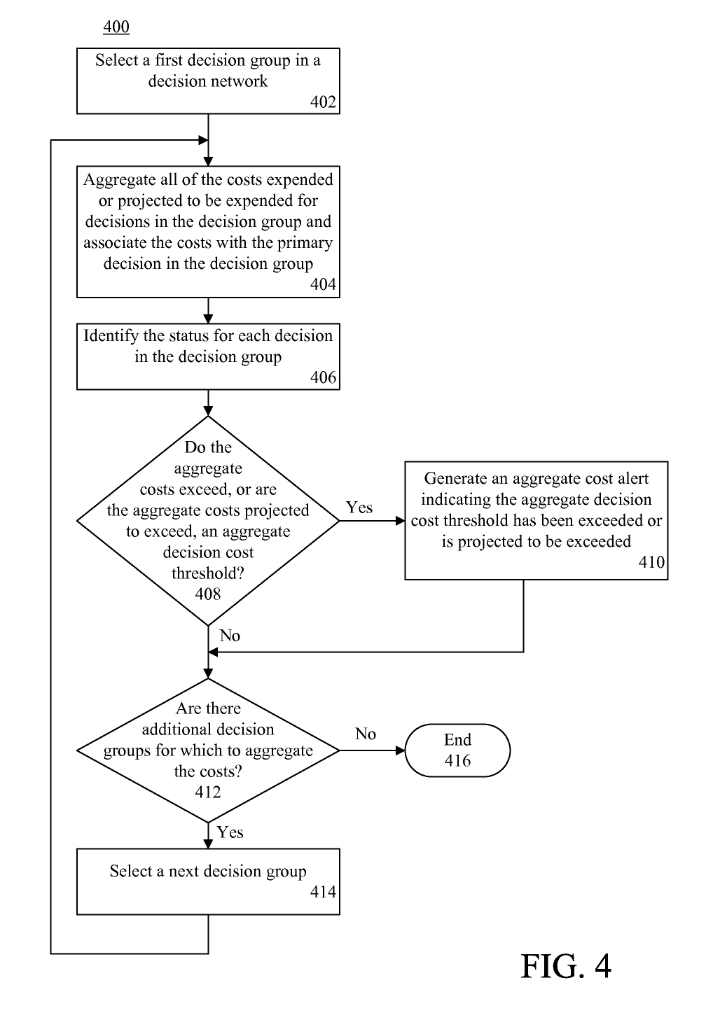

FIG. 4 is flowchart depicting another method 400 of decision planning that is useful for understanding the present invention. The method 400 can be implemented to monitor costs actually expended and/or projected to be expended for various decision groups in the decision network, and to again generate alerts when costs exceed, or are projected to exceed, cost threshold warning levels. As noted for the previous example, the method 400 can be implemented using data assigned to the respective decisions, and can be implemented periodically, in response to triggers, or can continually run while the decision network is active.

At step 402, a first decision group in the decision network can be selected. In one arrangement the first decision group can be a decision group having a primary decision that is in the second lowest decision level in the decision network. Specifically, in accordance with the definition of a primary decision presented herein, a primary decision will be in at least one subordinate decision at a lower decision level than the decision level at which the primary decision is located. Thus, primary decisions will be defined on decision levels above the lowest decision level, but not on the lowest decision level.

At step 404 all costs expended and/or projected to be expended for decisions in the decision group can be aggregated, and associated with the primary decision in the decision group. At step 406, the status of each decision in the decision group can be identified. For example, a determination can be made whether each decision is open or closed. Moreover, additional status information can be identified, for example whether information is needed for the decision to be made, what information is needed, etc.

At decision box 408, a determination can be made as to whether the aggregate costs of the decision group exceed, or are projected to exceed, an associated aggregation decision cost threshold assigned to the decision group. If so, at step 410 an aggregate cost alert can be generated and electronically communicated, for instance as previously described for other alerts. For example, the aggregate cost alert can be presented via a user interface of an electronic system. The aggregate cost alert can indicate that the aggregate decision costs exceed, or are projected to exceed, the aggregate decision cost threshold.

At decision box 412, a determination can be made as to whether there are additional decision groups for which to aggregate costs. If so, at step 414 a next decision group can be selected. In one arrangement, the next decision group can be another decision group having a primary decision at the same decision level as the present decision group. If there are no other such decision groups, then the next decision group can be selected to be a decision group having its primary decision one decision level higher than the primary decision of the present decision group. Continuing with this selection strategy, eventually the target decision will be reached. If there are no additional decision groups, the method 400 can proceed to step 416 and the process can end.

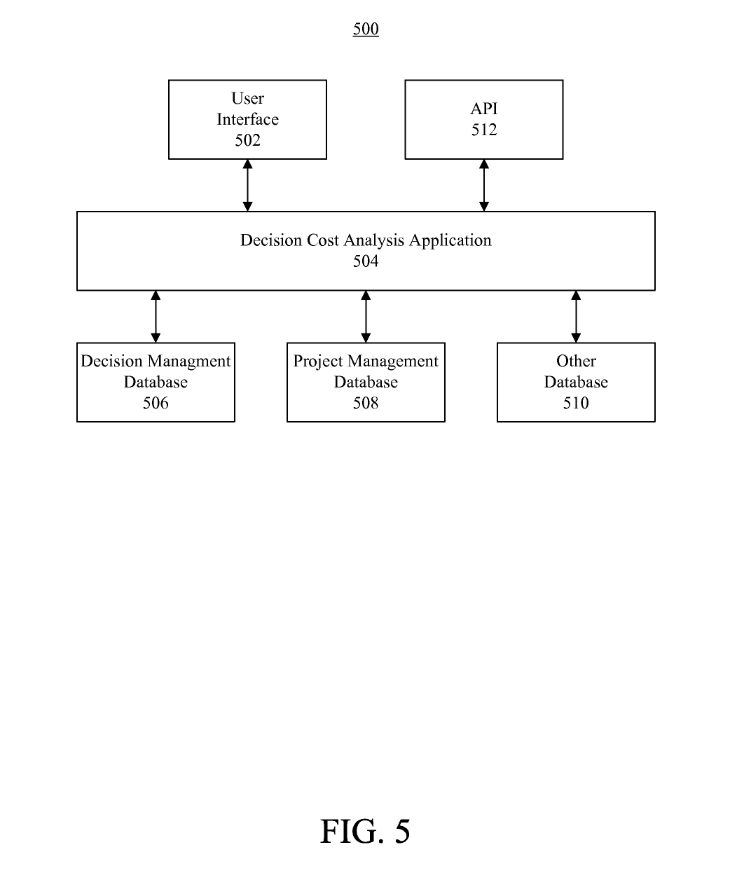

FIG. 5 depicts a block diagram of a decision management system 500 that is useful for understanding the present invention. The decision management system 500 can include a user interface 502, a decision cost analysis application 504, and a decision management database 506. Additional databases also can be provided, for example a project management database 508 and a database 510 for other data.

The decision cost analysis application 504 can be instantiated on the decision management system 500 to implement the methods and processes described herein. Further, the decision cost analysis application 504 can be communicatively linked to the user interface 502. The decision cost analysis application 504 can receive user inputs via the user interface, and present information to users via the user interface.

The decision cost analysis application 504 also can be communicatively linked to the databases 506-510. Accordingly, the decision cost analysis application 504 can store data to, and retrieve data from, the databases 506-510. For instance, the decision cost analysis application 504 can store to the decision management database 506 the various information generated in the previously described methods. Moreover, the decision cost analysis application 504 can access that information for any of a myriad of purposes, for instance to analyze such data and generate corresponding reports, data or alerts.

Further, the decision cost analysis application 504 can interface with any of a variety of other types of applications. For instance, the decision management system 500 can include an application program interface (API) 512 that is used by the decision cost analysis application 504 to interface with one or more decision-making and/or decision management applications that indicate decisions that should be made and/or provides their respective decision risk values or other related information.

The decision cost analysis application 504 can receive the decision information from the other application(s) (not shown) via the API 512, and store it to the decision management database 506. Moreover, decision cost analysis application 504 can provide to the other application(s), via the API 512, the data generated in the previously described methods in a manner suitable for such data to be processed by the other application(s).

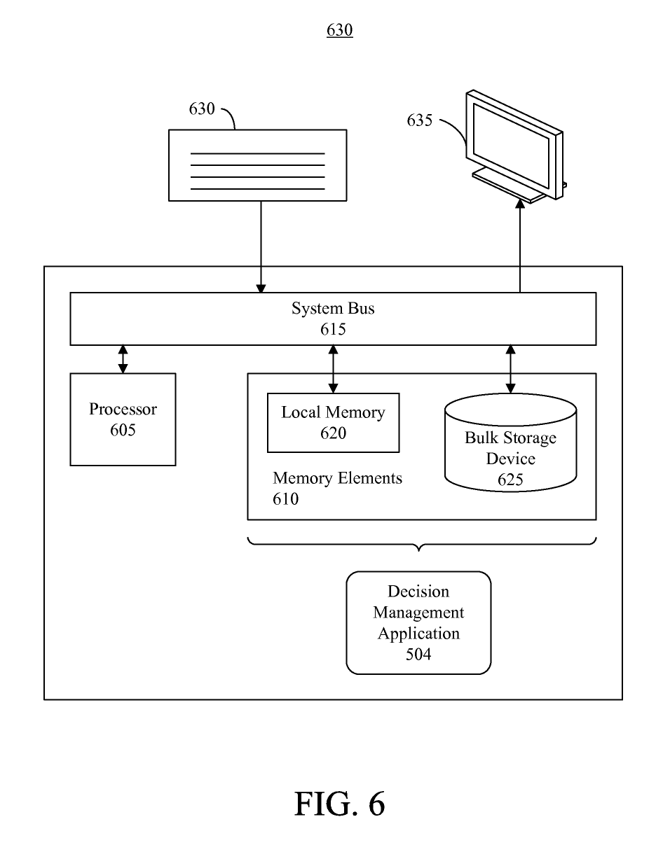

FIG. 6 is a block diagram illustrating an electronic system 600 that is useful for understanding the present invention. The electronic system 600 can be implemented as a computer (e.g., a server, a personal computer, a mobile computer (e.g., a laptop computer, a netbook, or the like), a mobile telephone (e.g., a cellular telephone, a smartphone, etc.), a personal digital assistant, a mobile terminal, an application specific device, or any other electronic device(s) that is configured to execute program code in accordance with methods and process described herein. In one arrangement, the electronic system 600 can include a plurality of computers and/or other devices. For instance, the electronic system 600 can include one or more computers that are servers, one or more computers that are clients, one or more mobile telephones, one or more personal digital assistants and/or one or more terminals.

The electronic system 600 can include at least one processor 605 coupled to memory elements 610 through a system bus 615. As such, the system 600 can store computer-usable program code within memory elements 610. The processor 605 can execute computer-usable program code accessed from the memory elements 610 via the system bus 615. In one arrangement, for example, the electronic system 600 can be implemented as computer that is suitable for storing and/or executing program code. It should be appreciated, however, that the electronic system 600 can be implemented in the form of any system comprising a processor and memory that is capable of performing the functions described within this specification. Moreover, when the electronic system 600 includes more than one device (e.g., computer, mobile telephone, etc.), each device may include the various components 605-615 described herein.

The memory elements 610 can include one or more physical memory devices such as, for example, local memory 620 and one or more bulk storage devices 625. Local memory 620 refers to random access memory or other non-persistent memory device(s) generally used during actual execution of the program code. The bulk storage device(s) 625 can be implemented as a hard drive or other persistent data storage device. The electronic system 600 also can include one or more cache memories (not shown) that provide temporary storage of at least some program code in order to reduce the number of times program code must be retrieved from the bulk storage device 625 during execution.

Input/output (I/O) devices such as a keyboard 630, a display 635, and a pointing device (not shown) optionally can be coupled to electronic system 600 as components of a user interface. Other I/O devices that may be coupled to the electronic system 600 may include, but are not limited to, buttons, keypads, soft-keys, touch screens, audio output devices, audio input devices, voice recognition devices, and so on. The I/O devices can be coupled to the system 600 either directly or through intervening I/O controllers, network adapters, or the like. Indeed, the electronic system 600 can include a plurality of user interfaces, each of which may be directly connected to a respective client or terminal.

The network adapters can be coupled to the electronic system 600 to enable various components of the electronic system 600 to communicate with one another. For example, clients can communicate with servers via the network adapters. Modems, cable modems, Ethernet cards and RF transceivers are examples of different types of network adapters that can be used with the system 600.

As pictured in FIG. 6, the memory elements 610 can store the decision cost analysis application 504. The decision cost analysis application 504, being implemented in the form of executable program code, can be executed by the processor 605 to implement the methods and processes described herein. The API, decision management database, project database and other databases depicted in FIG. 5 also can be stored in the memory elements 610, or can be accessed on other electronic systems that are communicatively linked to the electronic system 600.

Accordingly, the present invention can be realized in hardware or a combination of hardware and software. The present invention can be realized in a centralized fashion in one electronic system configured to perform processing on software and/or data, or in a distributed fashion where different elements are spread across several interconnected processing systems. Any kind of processing system or other apparatus adapted for carrying out the methods described herein is suited. A typical combination of hardware and software can be an electronic system with one or more processors and computer-usable program code that, when being loaded and executed, controls the electronic system such that it carries out the methods described herein.

The present invention also can be embedded in a computer-usable medium, such as a computer program product or other data programs storage device, readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The flowcharts and block diagram in the figures illustrate the architecture, functionality, and operation of possible implementations of systems, methods and computer program products according to various embodiments of the present invention. In this regard, each block in the flowcharts or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

As used herein, the term decision group means a group of one or more logically related decisions. The terms “computer program,” “software,” “application,” variants and/or combinations thereof, in the present context, mean any expression, in any language, code or notation, of a set of instructions intended to cause an electronic system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a gadget, a widget, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

This invention can be embodied in other forms without departing from the spirit or essential attributes thereof. Accordingly, reference should be made to the following claims, rather than to the foregoing specification, as indicating the scope of the invention.

What is claimed is:

1. A method of managing decisions, comprising:
identifying by an electronic system decision costs expended for each of a plurality of decisions in a decision network;
determining by the electronic system whether a sum of the decision costs expended or projected to be expended exceed at least one assigned cost threshold warning level;
when the sum of the decision costs expended or projected to be expended exceed the assigned cost threshold warning level, by the electronic system automatically generating a cost warning alert indicating that the cost threshold warning level has been exceeded or is projected to be exceeded; and
presenting the cost warning alert on a user interface of the electronic system.

2. The method of claim 1, further comprising;
for each of the decisions, determining by the electronic system whether an owner associated with the decision has an appropriate level of authority for the decision;
when the owner does not have an appropriate level of authority, the electronic system generating an authorization warning alert indicating that the owner does not have the appropriate level of authority for the decision; and
presenting the authorization warning alert on the user interface of the electronic system.

3. The method of claim 2, wherein determining by the electronic system whether the owner associated with the decision has an appropriate level of authority for the decision comprises:
determining by the electronic system whether the sum of decision costs exceed an amount for which the owner associated with the decision is authorized to manage.

4. The method of claim 2, further comprising:
on the electronic system, storing data pertaining to decisions in which the respective owners lack the appropriate level of authority to manage the decisions;
with the electronic system, analyzing the data to evaluate trends relating to the owners expending or a projection that the owners will expend more costs than they are authorized; and
outputting an analysis of the data.

5. The method of claim 1, further comprising:
determining by the electronic system whether there are any open decisions remaining in the decision network; and
when there are open decisions remaining in the decision network, by the electronic system identifying the open decisions and outputting a listing of the open decisions.

6. The method of claim 1, comprising:
by the electronic system selecting at least one decision group in the decision network, the decision group comprising a plurality of the decisions;
by the electronic system aggregating all of the decision costs expended or projected to be expended for each of the decisions in the decision group; and
when the aggregate costs exceed or are projected to exceed an aggregate cost threshold, by the electronic system generating an aggregate cost alert indicating that an aggregate decision cost threshold is exceeded or is projected to be exceeded;
presenting the aggregate cost alert on a user interface of the electronic system.

7. The method of claim 6, further comprising:
by the electronic system defining the decision group to comprise a primary decision and at least one subordinate decision;
wherein:
the primary decision is based, at least in part, on the subordinate decision, or the primary decision constrains the subordinate decision; and
the subordinate decision is at a second decision level in the decision network that is lower than a first decision level at which the primary decision is located.

8. The method of claim 7, further comprising:
by the electronic system associating the aggregate costs for each of the decisions in the decision group with the primary decision.

9. The method of claim 1, further comprising:
assigning an owner to each of the decisions in the decision network.

10. The method of claim 1, wherein the decision cost threshold warning level is based, at least in part, on a decision risk value assigned to each of the decisions.

11. A computer program product comprising:
a computer-usable medium comprising computer-usable program code that manages decisions, the computer-usable medium comprising:
computer-usable program code that identifies decision costs expended or projected to be expended for each of a plurality of decisions in a decision network;
computer-usable program code that determines whether a sum of the decision costs expended or projected to be expended exceed at least one assigned cost threshold warning level; and
computer-usable program code that, when the sum of the decision costs expended or projected to be expended exceed the assigned cost threshold warning level, automatically generates a cost warning alert indicating that the cost threshold warning level has been exceeded or is projected to be exceeded; and
computer-usable program code that presents the cost warning alert on a user interface of an electronic system.

12. The computer program product of claim 11, the computer-usable medium further comprising:
computer-usable program code that for each of the decisions determines whether an owner associated with the decision has an appropriate level of authority for the decision;
computer-usable program code that, when the owner does not have an appropriate level of authority, generates an authorization warning alert indicating that the owner does not have the appropriate level of authority for the decision; and
computer-usable program code that presents the authorization warning alert on the user interface of the electronic system.

13. The computer program product of claim 12, wherein the computer-usable program code that determines whether an owner associated with the decision has an appropriate level of authority for the decision comprises:
computer-usable program code that determines whether the sum of decision costs exceed an amount for which the owner associated with the decision is authorized to manage.

14. The computer program product of claim 12, the computer-usable medium further comprising:
computer-usable program code that stores on the electronic system data pertaining to decisions in which the respective owners lack the appropriate level of authority to manage the decisions;
computer-usable program code that analyzes the data to evaluate trends relating to the owners expending or a projection that the owners will expend more costs than they are authorized; and
computer-usable program code that outputs an analysis of the data.

15. The computer program product of claim 11, the computer-usable medium further comprising:
computer-usable program code that determines whether there are any open decisions remaining in the decision network; and
computer-usable program code that, when there are open decisions remaining in the decision network, identifies the open decisions and outputs a listing of the open decisions.

16. The computer program product of claim 11, the computer-usable medium further comprising:
computer-usable program code that selects at least one decision group in the decision network, the decision group comprising a plurality of the decisions;
computer-usable program code that aggregates all of the decision costs expended or projected to be expended for each of the decisions in the decision group;
computer-usable program code that, when the aggregate costs exceed or are projected to exceed an aggregate cost threshold, generates an aggregate cost alert indicating that an aggregate decision cost threshold is exceeded or is projected to be exceeded; and
computer-usable program code that presents the aggregate cost alert on a user interface of the electronic system.

17. The computer program product of claim 16, the computer-usable medium further comprising:
computer-usable program code that defines the decision group to comprise a primary decision and at least one subordinate decision;
wherein:
the primary decision is based, at least in part, on the subordinate decision, or the primary decision constrains the subordinate decision; and
the subordinate decision is at a second decision level in the decision network that is lower than a first decision level at which the primary decision is located.

18. The computer program product of claim 17, the computer-usable medium further comprising:
computer-usable program code that associates the aggregate costs for each of the decisions in the decision group with the primary decision.

19. The computer program product of claim 11, the computer-usable medium further comprising:
computer-usable program code that assigns an owner to each of the decisions in the decision network.

20. The computer program product of claim 11, wherein the computer-usable program code that determines whether the sum of the decision costs expended or projected to be expended exceed an assigned cost threshold warning level comprises:
computer-usable program code that bases the decision cost threshold warning level, at least in part, on a decision risk value assigned to each of the decisions.
